(19) United States
(12) Patent Application Publication
(10) Pub. No.: US 2011/0320442 A1
(43) Pub. Date: Dec. 29, 2011

(54) Systems and Methods for Semantics Based Domain Independent Faceted Navigation Over Documents

(75) Inventors: Tanveer A. Faruquie, New Delhi (IN); Mukesh K. Mohania, Rajpur Chung (IN); Ullas B. Nambiar, Haryana (IN)

(73) Assignee: INTERNATIONAL BUSINESS MACHINES CORPORATION, Armonk, NY (US)

(21) Appl. No.: 12/823,671

(22) Filed: Jun. 25, 2010

(51) Int. Cl. G06F 17/30

(52) U.S. Cl. 707/723; 707/769; 707/E17.014

(57) ABSTRACT

Systems and associated methods providing a document corpus navigation interface including domain independent facets are described. Embodiments provide a list of domain independent facets, extract facet values from the document corpus, learn the facet values from the corpus, map each document to one of the values of each of the facets, and automatically determine a weight of the relationship.

### BACKGROUND

The subject matter presented herein generally relates to systems and methods for faceted searching.

Traditional web search/browse tools allow a user to enter one or more key words and search for documents (web pages). However, depending on the adequacy of the key words used, too many or too few results may be obtained. Moreover, certain collections of documents (corpus) are not amendable to searching with traditional web search/browse tools.

Faceted search/browse tools allow for simultaneous exploration of many aspects of a topic, and gradual “zooming in” on the information target. Faceted search tools tend to reduce frustration in as much as multi-faceted search applications ensure only valid choices are presented, so zooming in on a subset of results does not yield an empty result set. Faceted search tools also support browsing in a context where the user is not sure of what to ask for in a multi-dimensional information space.

Facets may be used to organize a document corpus. Facets may be based on metadata, which includes structured information about resources (documents). For example, metadata can include a set of hierarchical subject labels, such as a category. Often metadata has several facets or attributes in various sets of categories. Such information is commonly stored in a database of record fields. A common example of faceted metadata includes a song catalog (songs have attributes such as artist, title, release date, track length, and the like).

### BRIEF SUMMARY

Embodiments broadly contemplate systems and methods for building a document corpus navigation interface comprising domain independent facets and values derived from the content by performing semantic analysis. Embodiments provide a list of domain independent facets, extract (adaptively and iteratively) facet values from the document corpus, provide an efficient semantic analysis that learns the facet values from the corpus, maps each document (or portion thereof) to one of the values of each of the facets, and automatically determines the weight of the relationship. Embodiments can also utilize syntactic features (or other document metadata) to enrich the analysis. Thus, embodiments provide a keyword query answering/navigating interface that can dynamically show new documents as a user refines the query or navigates along one of the dimensions.

In summary, one aspect provides a method comprising: providing a navigation interface having one or more domain independent facets; receiving a query input to the navigation interface; extracting one or more values for the one or more domain independent facets from a document corpus; and providing one or more query results derived from the document corpus and arranged according to the one or more domain independent facets.

Another aspect provides a computer program product comprising: a computer readable storage medium having computer readable program code embodied therewith, the computer readable program code comprising: computer readable program code configured to provide a navigation interface having one or more domain independent facets; computer readable program code configured to receive a query input to the navigation interface; computer readable program code configured to extract one or more values for the one or more domain independent facets from a document corpus; and providing one or more query results derived from the document corpus and arranged according to the one or more domain independent facets.

A further aspect provides a system comprising: one or more processors; and a memory operatively connected to the one or more processors; wherein, responsive to execution of computer readable program code accessible to the one or more processors, the one or more processors are configured to: provide a navigation interface having one or more domain independent facets; receive a query input to the navigation interface; extract one or more values for the one or more domain independent facets from a document corpus; and provide one or more query results derived from the document corpus and arranged according to the one or more domain independent facets.

The foregoing is a summary and thus may contain simplifications, generalizations, and omissions of detail; consequently, those skilled in the art will appreciate that the summary is illustrative only and is not intended to be in any way limiting.

For a better understanding of the embodiments, together with other and further features and advantages thereof, reference is made to the following description, taken in conjunction with the accompanying drawings. The scope of the invention will be pointed out in the appended claims.

### BRIEF DESCRIPTION OF THE SEVERAL VIEWS OF THE DRAWINGS

FIG. 1 illustrates an example, high level flow for building a document corpus navigation interface.

FIG. 2 illustrates an example method of document concept analysis.

FIG. 3 illustrates an example method of document author profiling.

FIG. 4 illustrates an example method for automated concept selection.

FIG. 5 illustrates an example computer.

### DETAILED DESCRIPTION

It will be readily understood that the components of the embodiments, as generally described and illustrated in the figures herein, may be arranged and designed in a wide variety of different configurations in addition to the described example embodiments. Thus, the following more detailed description of the example embodiments, as represented in the figures, is not intended to limit the scope of the claims, but is merely representative of those embodiments.

Reference throughout this specification to “one embodiment” or “an embodiment” (or the like) means that a particular feature, structure, or characteristic described in connection with the embodiment is included in at least one embodiment. Thus, appearances of the phrases “in one embodiment” or “in an embodiment” or the like in various places throughout this specification are not necessarily all referring to the same embodiment.

Furthermore, the described features, structures, or characteristics may be combined in any suitable manner in one or more embodiments. In the following description, numerous specific details are provided to give a thorough understanding of example embodiments. One skilled in the relevant art will recognize, however, that aspects can be practiced without one or more of the specific details, or with other methods, components, materials, et cetera. In other instances, well-known structures, materials, or operations are not shown or described in detail to avoid obfuscation.

In this regard, to highlight certain aspects, blogs are used as a non-limiting example of documents, an example set of domain independent facets is provided, examples of automated value extraction for the domain independent facets are described, and an example weighting scheme is described herein. However, it should be understood that the general principles described herein in accordance with the various example embodiments operating on blogs are equally applicable to other document corpuses, such as enterprise email corpuses and the like.

Key word based search engines are a well known and widely used tool to find relevant web pages quickly from the web, and, from a blog reader's point of view, blogs and web pages should have similar searching/browsing tools. However, blogs are a different kind of document in several respects, making them somewhat inaccessible to traditional search engines. For example, blogs change much more rapidly than other web pages, often multiple times during a day. Therefore, specialized blog-searching tools become desirable. In fact, several specialized search engines covering the blogosphere are available, while the commercial search engines have a separate blog search offering (for example, GOOGLE® Blog search tool). GOOGLE is a registered mark of Google, Inc. in the United States and other countries.

Moreover, conventional web search engines provide a ranked list of web pages where the keywords appear. However, this model does not fit the blogosphere because the popular link analysis based metrics used generally by search engines (for example, the PAGERANK® algorithm) does not work well for blog searching, for example because blogs are somewhat sporadic and weakly linked together. PAGERANK is a registered mark of Google Technology Inc. in the United States and other countries.

Additionally, blog readers might be interested in viewing their search results in manner different from that used to show web pages. In particular, a reader might want to see blogs that contain the query but provide differing viewpoints about it. Furthermore, the reader might want the blogs to be differentiated by how specialized the blog is for the given query. The reader may also want to know what is the general outlook (positive or negative) of the blog in terms of the searched query.

While faceted search tools exist, building traditional faceted search systems is a time consuming because it traditionally involves manual building of facets for a document corpus. Still further, once these custom facets have been designed for the particular domain, the inexperienced user is faced with navigating through an unfamiliar interface.

Accordingly, embodiments provide the user with a search engine that takes a key word query, but instead of a ranked list of documents (for example, blogs), returns a clustered set of documents that can be navigated by selecting the orthogonal aspects of the documents, called facets. Unlike the many faceted search systems already available, the facets produced by the embodiments are domain independent. A domain independent facet is a facet that is generally applicable across domains (document types) and therefor allows uniformity in facets utilized.

A reason for using domain independent facets is that users are unlikely to know all values of a domain specific facet. Moreover, providing the same set of facets across different domains makes the interface more static or uniform, and hence easier to understand and use. Example domain independent facets useful in the context of blogs are described herein to highlight important characteristics of domain independent facets. The example domain independent facets are based on features of traditional web searching, as this is most familiar to users.

Blogs are used as an example document corpus because they are a popular type of document that highlights document corpus characteristics that make certain document corpuses somewhat inaccessible to conventional search engines. To provide some useful contextual information, a brief discussion of blogs is provided herein, as blogs are used as example documents throughout.

A blog is a self-publishing media on the web that allows millions of people to easily publish and share their ideas, experiences and expertise. Blog is a contraction of the term “weblog”, and is a type of web site, usually maintained by an individual with regular entries of commentary, descriptions of events, or other material such as graphics or video. Blog entries are commonly displayed in reverse-chronological order. A typical blog combines text, images, and links to other blogs, web pages, and other media related to its topic. Creation and maintenance of a blog is referred to as blogging. Most blogs are primarily textual, although some focus on art, photographs, videos, music (MP3 blog), and audio (podcasting).

Regarding a usable set of domain independent facets, example embodiments are described herein with reference to distinct and orthogonal domain independent facets that virtually any blog can be classified into. In this context, the domain independent facets include but are not necessarily limited to: the concepts/topics the blog deals with, the profile of the author (for example, the writer of a blog), the purpose for which the blog was written, the time associated with the blog (creation, update, or the like), and the geography associated with the blog (location of creation, topic, and the like).

The example domain independent facets (concept, author profile, and purpose) provide an almost complete model for the blog context; however, these example domain independent facets can be modified/extended/replaced to accommodate other document corpuses, such as enterprise documents (for example, an email corpus). To provide further clarity to the description, particular focus is given to the domain independent facets of concept and profile, as the principles discussed in connection with these facets are extendable to other domain independent facets, either for use with blogs or other document corpuses.

The domain about which a blog is produced will be captured by the concept (examples of concepts being movies, sports, politics, IT, et cetera). The motivation behind creating/maintaining a blog will be captured by the purpose (examples of purposes being social commentary, expertise sharing, product reviewing, experience sharing, et cetera). Additionally, the author profile will establish an implicit level of trust (examples of profiles being expert, generalist, critique, problem solver, et cetera).

Accordingly, example embodiments are described that provide an easy-to-comprehend, high level, domain independent facet model that can be superimposed over the blogosphere. Embodiments build a faceted search interface that considers attributes as facets over which users would be interested in searching. Embodiments provide a system that learns the domain independent facet values for each blog encountered in the blogosphere. This avoids the long and tedious process involved in deriving useful facets to describe the content.

The description now turns to the figures. The illustrated embodiments will be best understood by reference to the figures. The following description is intended only by way of example and simply illustrates certain selected example embodiments representative of the invention, as claimed.

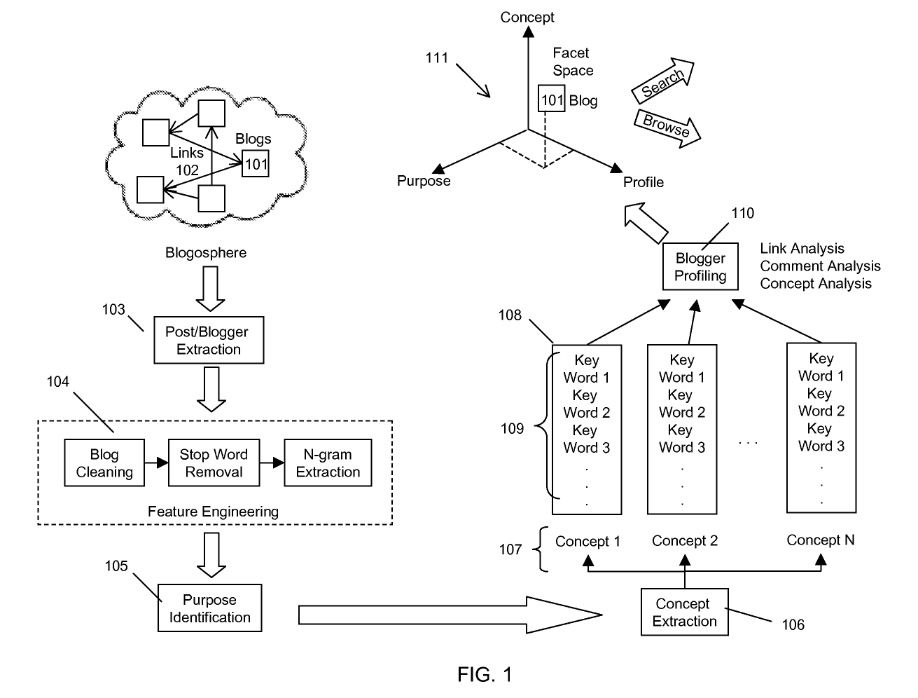

FIG. 1 illustrates an example, high level flow for building a document corpus navigation interface. Specifically, the example illustrated depicts automatic extraction of values for three domain independent facets: concept, purpose, and profile. The values are derived from the blogs themselves by performing semantic analysis of the blog posts.

As shown, in the blogosphere, each blog 101, which contains one or more posts, can be linked 102 to other blogs or web pages. Each blog 101 is used as an example document with some uniform characteristics, namely, the presence of permalink (permanent link to a post), post identification, blog number, time and the post-body (for example, text content). Here, blog post (or simply post) stands for a distinct entry made by the author. For the purposes of the description of example embodiments, the comments that are left by readers of the blog 101 are not considered, though this information can be used to further learn about the topic of the post, the purpose of the post, or the like.

For each blog 101, information is extracted 103 regarding the post(s) and represented as plain text documents suitable for semantic analysis. To accomplish this, feature engineering 104 is performed, for example as by cleaning the extracted information by removing unnecessary tags (like <p>, <div>, <br> et cetera) from the post-body content, performing word stemming (term normalization, for example using a Porter stemmer), performing stop word removal, and performing N-gram extraction (pattern extraction). Each blog post is thus represented as a plain text document, one for each unique permalink.

Responsive to feature engineering 104, purpose identification can be also conducted. Learning the true purpose of the blog is difficult. However, the techniques used for extracting concepts 106 (and mapping thereof) can be used to learn purpose (or other document attributes) as well. For example, key words associated with a blog can be used to ascertain a purpose of the blog, as discussed in connection with concept extraction.

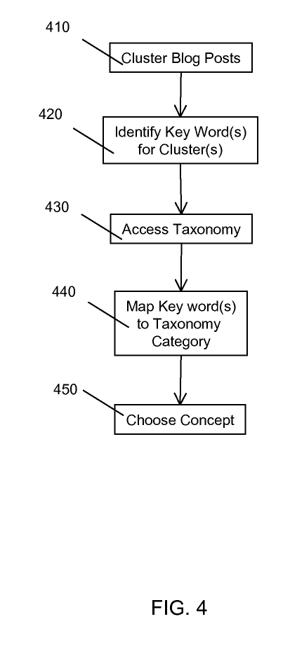

Taking concept extraction 106 as a representative example, embodiments utilize the blogs 101 themselves to identify concepts 107 that are being referred to therein. Clustering can be utilized in connection with concept extraction. Clustering algorithms divide data into meaningful groups, called clusters, such that the intra-cluster similarity is maximized and the inter-cluster similarity is minimized. Discovered clusters can be used to explain characteristics, such as concept, of the underlying data distribution. By clustering the blog posts and extracting the most common and informative keywords 109 from each cluster 108, embodiments determine what concept(s) are being referred to in the blogs 101. FIG. 4 provides a further description of an example of auto labeling (mapping) the concept(s).

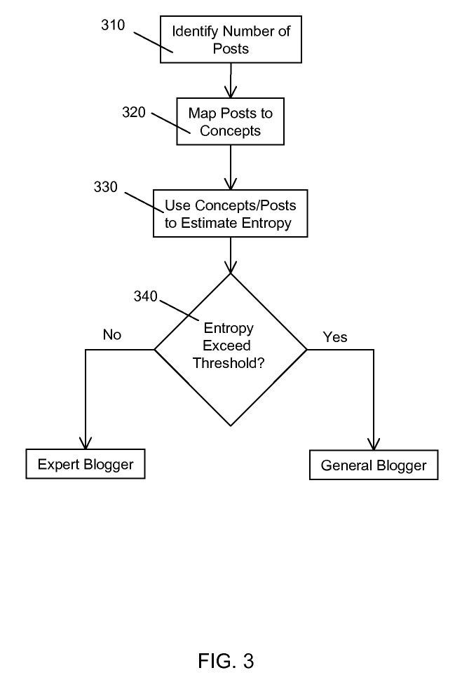

Additionally, responsive to feature engineering 104, blogger profiling 110 can be performed. A blogger profile may be useful to a user wanting to evaluate the blogger authoring or associated with the blog. Blogger profiling can be based on a variety of metrics, such as the number of posts directed to a particular concept. As an example method of profiling, a binary analysis for distinguishing between an expert blogger and a generalist blogger is described in connection with FIG. 3.

Once purpose identification 105, concept extraction (and mapping) 106, blogger profiling 110 and/or other techniques for deriving domain independent facet values have been completed, these can be utilized to provide a multidimensional search/browse interface 111 to the user. The user will thus be enabled to search or browse through the corpus of documents (blogs in this example) using any of the domain independent facets characterizing the documents.

By way of further refinement, to map blog posts to concepts, example embodiments employ a cluster-mapping model. The example mapping process assumes that each permalink points to a single blog written by a single author, that each individual blog post will map only to a single concept, and that blogs can map to multiple concepts (by virtue of multiple blog posts).

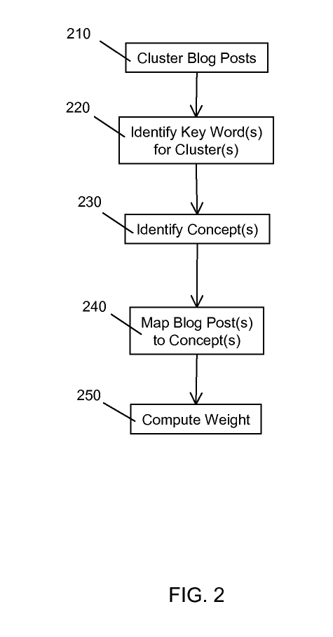

Referring to FIG. 2, example embodiments map each post in the original permalink document to a single concept. The blog posts are first clustered 210. For each cluster, one or more key word(s) can be identified 220. Once the concepts are identified 230, as discussed further in connection with FIG. 4, embodiments map 240 a blog post containing any of the keywords associated with a concept as referring to the concept. Embodiments can compute 250 a post-concept weight, for example, as a weighted summation of the keywords mapping to the concept and appearing in the post. The concept with maximum post-concept weight can be chosen as the one being referred to in the post. The larger document itself (for example, a blog containing a plurality of posts) can be similarly mapped to a concept based on a weighted sum of all posts that map to the concept.

To measure similarity of blogs, since the blogs are represented as documents, embodiments can compute a similarity between two blogs using any document similarity estimation technique, such as Cosine similarity. Cosine similarity is a pure syntactic similarity estimator, and since concepts have been extracted and mapped to the documents, embodiments can use a blog-concept mapping table to represent each blog as a vector of concept, with the strength of the mapping used as weights. This results in measuring the blog similarity as a function of the commonality of high level concepts. Thus, the similarity measure is the semantic similarity between the blog.

Embodiments learn blogger profiles to assist in ordering blog search results. An interest is in identifying profiles or roles that can span many domains (for example, expert/specialist, generalist, self-blogger, observer/commentator, critique et cetera). Many of these profiles may be interconnected. For automatically learning these profiles in a fashion similar to concept estimation, the easiest profiles to identify may be those of a person that is an expert in a given area and those of a person that is a general blogger in a given area. Experts may have a number of posts that would refer to the same concept; hence, expert posts would have less noise or randomness. The production of blogger profiles for bloggers that are experts and those that are general bloggers, and the distinction there between, will therefore be used as non-limiting examples of blogger profiling.

Embodiments can use entropy estimation to conduct blogger profiling. For example, entropy estimation is used in Information Theory to judge the disorder in a computer system. Simply put, as entropy of the system increases the system is more disordered. In the example case used herein, the system of interest is the blog document. For blogs, one can assume that as the number of posts increases, the disorder and hence the entropy of the blog would increase, if the blogger did not devote his or her posts to a single (or few) concepts. Therefore, by estimating the entropy of each blog document with respect to the number of posts, embodiments can identify blogs and consequently bloggers that can be categorized as experts. The concepts for which these bloggers can be assumed as experts can be determined from the blog-concept mapping table described herein. In general, it is expected that the blogs with larger posts have higher entropy and the smaller blogs are more aligned to a specific topic.

Referring to FIG. 3, an example of blogger profiling is illustrated. The number of posts is identified 310 for a particular blogger. The posts are mapped 320 to one or more concepts, as described herein. As described, the number of posts for a concept is indicative of entropy; thus, entropy can be estimated 330 using a comparison of posts per concept, with many posts for few concepts indicating low entropy. If the entropy is determined to exceed a predetermined threshold 340, the blog can be categorized as containing posts on many different concepts (high entropy), and thus the blogger profiled as a general blogger. In contrast, if it is determined 340 that the entropy of the blog posts is lower than the threshold, the blogger can be profiled as an expert, having many posts for a particular concept.

Additional techniques can be applied to further increase such a profiling analysis. For example, it could be possible that a blog is caught early in its existence and so what looks like an expert might in fact be a generalist. One way to overcome this is to re-classify at periodic intervals. An alternate approach is to use additional metrics in classifying the blogger, such as using syntactic metrics (like the number of people linking to the blog). Thus, there is some value in using the syntactic metrics, especially if they point to specific posts and not to the blog itself.

Example embodiments were evaluated with respect to computing blog clusters to identify concepts, building a blog-concept mapping table/graph, and estimating blog-blog similarity. In particular, example embodiments were utilized for generation of descriptive labels for blog clusters based on WIKIPEDIA® classification trees, and comparisons were made with human assigned labels. These computations indicate the example embodiments provide relevant blogs as answers to a user's query and also provide a three-dimensional browsing interface to the user (based on the domain independent facets utilized). WIKIPEDIA is a registered mark of Wikimedia Foundation, Inc. in the United States and other countries.

For an example evaluation, a test data set (BLOG06) used in the TREC06 2 Blog track was utilized. This set (BLOG06) was created and distributed by the University of Glasgow. It contains a crawl of blog feeds, and associated Permalink 3 and homepage documents (from late 2005 and early 2006). Ten thousand permalink documents were utilized for the evaluation. Three hundred and thirty nine distinct blogs were extracted from these documents. A smaller data set was utilized for ease of manually computing the concepts and also verifying the identified relationships, as generated by the example embodiments under evaluation.

For clustering the blogs extracted, a clustering tool called CLUTO was used. Using CLUTO, twenty blog document clusters were created and informative (discriminative) keywords describing the clusters were obtained. The representative keywords for each cluster was shown to a small group of human evaluators, and these evaluators were asked to manually label the clusters to real-world concepts. Table 1 shows some of the concepts from such a mapping.

TABLE 1
Concepts assigned to Blog Clusters by Human Evaluators

| No. | Concept | Keywords | Cluster |
|---|---|---|---|
| 1 | Gambling | Poker, Casino, Gamble | 2 |
| 2 | Birthdays | Birthday, | 3 |
| | | Whatdoesyourbirthdatemeanquiz | |
| 3 | Classifieds | Classifieds, Coaster, | 4 |
| | | Rollerblade, Honda | |
| 4 | Podcast | Podcasts, Radio, Scifitalk | 5 |
| 5 | Christmas | Christmas, Santa, Tree, Gomer | 6 |
| 6 | Finance | Cash, Amazon, Payday | 7 |
| 7 | Comics | Comic, Seishiro | 9 |
| 8 | Thanksgiving | Thankful, Food, Dinner, | 11 |
| | | Shopping | |
| 9 | Movies | Movie, Harry, Potter, Rent | 13 |
| 10 | IT | Code, Project, Server, | 16 |
| | | Release, Wordpress | |
| 11 | Cars | Car, Drive, Money, Kids | 18 |
| 12 | Books | Book, Art, Science, Donor | 19 |
| 13 | Others | Dating, Cards, NBA, | 1, 12, 14, |
| | | Napoleon, Halloween, | 15, 20 |
| | | Homework, Hair | |

The most common concept was selected as the single best label for a cluster. A few clusters to which no clear semantic label could be assigned were mapped to a generic concept (Other(s)). This was done since those clusters did not bring out strong informative keywords (that is, there were not many keywords that appeared repetitively in the posts belonging to those clusters).

While the above process is human-intensive, embodiments can utilize an automatic way of labeling the clusters with semantic labels, such as concept. This task is easier if there exists a taxonomy of concepts that map to keywords. Fortunately, such taxonomies exist.

For example, WIKIPEDIA® categories provide a good taxonomy that covers many of the general topics that appear in blogs. Accordingly, embodiments can utilize an interface, such as the interface provided by DBPedia, to map descriptive keywords from a cluster to WIKIPEDIA® categories.

Referring to FIG. 4, an example of using taxonomy categories as concepts for is illustrated. Once blog posts have been clustered 410, and key words have been identified for the clusters 420, a taxonomy can be accessed 430 to map key words to taxonomy categories 440, and a category can be chosen 450 as a concept. As an example, for each keyword, the top-20 WIKIPEDIA® categories were extracted and then a label was chosen for the cluster concept. Table 2 shows the labels extracted for 10 clusters.

TABLE 2
Concepts Learned from Categories.

| Cluster | Mid-Sup. Concept | Max-Sup. Concept |
|---|---|---|
| 1 | Band | Album |
| 2 | Book | Actor |
| 3 | Supernatural | Place |
| 4 | Single | Place |
| 5 | Book | Place |
| 6 | Company | Place |
| 7 | Bird of Surname | Place |
| 8 | Place | Place |
| 9 | Military Conflict | Vehicle |
| 10 | Political Entity | Album |

The Mid-Support Concept is the WIKIPEDIA® category that had a medium level of support from all the categories that were extracted. Max-Support is the one the maximums support. Here, the support is the count returned by DBPedia along with the categories. An alternate model is to map each blog itself to a concept by extracting representative words based on a tf-idf (term frequency-inverse document frequency) style ranking The blog clustering is then done on the WIKIPEDIA® categories and all blogs that map to similar categories are packed into one with a representative label assigned to it.

Embodiments can also provide graphic representations of measured semantic similarity. In similarity graphs, the nodes represent individual blogs, and an edge is drawn between nodes if the blogs show some similarity. Groups of blogs coming together and forming local clusters can be identified in the graph, which represents similarity between the blogs in the cluster. This is useful inasmuch as any blog in the cluster would be an able replacement to any other blog in such a cluster. Such information allows suggestions of alternatives to a regular reader of a particular blog.

Two relevant domain independent facets (dimensions), namely geography and temporal information, have not been discussed in great detail herein. Deciding to include a geographic and/or temporal dimension is possible, and the inclusion can be based on the various possibilities given the available information. For example, in terms of geography, while the location of a blogger may be given as part of the profile (or otherwise accessible as metadata), at times the content itself might refer to a different geographic location (for example, a vacation report referring to Hawaii). Similarly, with regard to time or temporal information, post-date is an easily obtainable metadata field, but the post and/or blog itself maybe referring to other times (for example, past experiences or events). Accordingly, embodiments support inclusion of one or more of these dimensions such that they can be added to or replace one or more of the dimensions described herein.

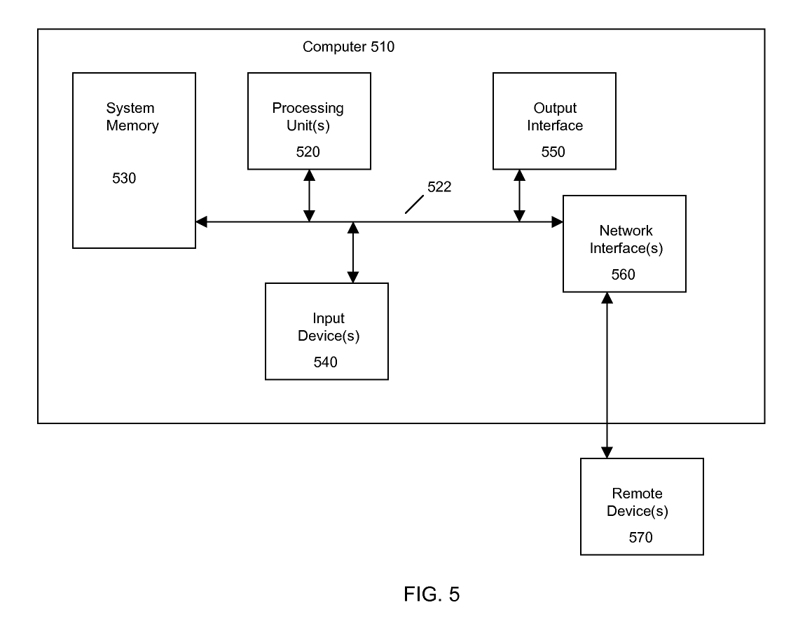

Referring to FIG. 5, it will be readily understood that certain embodiments can be implemented using any of a wide variety of devices or combinations of devices. An example device that may be used in implementing one or more embodiments includes a computing device in the form of a computer 510. In this regard, the computer 510 may execute program instructions configured to accept query input from a user, access one or more document corpuses, apply domain independent facets and automatically ascertain values therefor, and perform other functionality of the embodiments, as described herein.

Components of computer 510 may include, but are not limited to, a processing unit 520, a system memory 530, and a system bus 522 that couples various system components including the system memory 530 to the processing unit 520. Computer 510 may include or have access to a variety of computer readable media. The system memory 530 may include computer readable storage media in the form of volatile and/or nonvolatile memory such as read only memory (ROM) and/or random access memory (RAM). By way of example, and not limitation, system memory 530 may also include an operating system, application programs, other program modules, and program data.

A user can interface with (for example, enter commands and information) the computer 510 through input devices 540. A monitor or other type of device can also be connected to the system bus 522 via an interface, such as an output interface 550. In addition to a monitor, computers may also include other peripheral output devices. The computer 510 may operate in a networked or distributed environment using logical connections to one or more other remote computers or databases, such as databases storing IT system information or consolidation strategies and/or impact rules. The logical connections may include a network, such local area network (LAN) or a wide area network (WAN), but may also include other networks/buses.

It should be noted as well that certain embodiments may be implemented as a system, method or computer program product. Accordingly, aspects of the invention may take the form of an entirely hardware embodiment, an entirely software embodiment (including firmware, resident software, micro-code, et cetera) or an embodiment combining software and hardware aspects that may all generally be referred to herein as a “circuit,” “module” or “system.” Furthermore, aspects of the invention may take the form of a computer program product embodied in one or more computer readable medium(s) having computer readable program code embodied therewith.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, et cetera, or any suitable combination of the foregoing.

Computer program code for carrying out operations for aspects of the invention may be written in any combination of one or more programming languages, including an object oriented programming language such as Java™, Smalltalk, C++ or the like and conventional procedural programming languages, such as the “C” programming language or similar programming languages. The program code may execute entirely on the user's computer (device), partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the invention are described herein with reference to flowchart illustrations and/or block diagrams of methods, apparatuses (systems) and computer program products according to example embodiments. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

In brief recapitulation, the problem of building domain independent faceted search interfaces over blogs was used as a non-limiting example of embodiments providing a domain independent faceted search interface. Domain independent, semantics-based set of facet values can be extracted from documents (such as the blogs discussed herein) in an automated fashion, permitting the user to search/browse a document corpus using the domain independent facets.

This disclosure has been presented for purposes of illustration and description but is not intended to be exhaustive or limiting. Many modifications and variations will be apparent to those of ordinary skill in the art. The example embodiments were chosen and described in order to explain principles and practical application, and to enable others of ordinary skill in the art to understand the disclosure for various embodiments with various modifications as are suited to the particular use contemplated.

Although illustrated example embodiments have been described herein with reference to the accompanying drawings, it is to be understood that embodiments are not limited to those precise example embodiments, and that various other changes and modifications may be affected therein by one skilled in the art without departing from the scope or spirit of the disclosure.

What is claimed is:

1. A method comprising:
providing a navigation interface having one or more domain independent facets;
receiving a query input to the navigation interface;
extracting one or more values for the one or more domain independent facets from a document corpus; and
providing one or more query results derived from the document corpus and arranged according to the one or more domain independent facets.

2. The method according to claim 1, wherein extracting one or more values for the one or more domain independent facets from a document corpus further comprises mapping each document to the one or more values.

3. The method according to claim 1, further comprising ranking the one or more query results.

4. The method according to claim 3, wherein ranking further comprises ranking according to semantic features of one or more documents included in the document corpus.

5. The method according to claim 4, wherein the ranking further comprises ranking according to syntactic features of one or more documents included in the document corpus.

6. The method according to claim 1, further comprising dynamically providing one or more other query results responsive to a navigation action applying one of the one or more domain independent facets.

7. The method according to claim 1, wherein the query input includes one or more key words.

8. The method according to claim 1, wherein the document corpus comprises web documents.

9. The method according to claim 1, wherein the document corpus comprises enterprise documents.

10. A computer program product comprising:
a computer readable storage medium having computer readable program code embodied therewith, the computer readable program code comprising:
computer readable program code configured to provide a navigation interface having one or more domain independent facets;
computer readable program code configured to receive a query input to the navigation interface;
computer readable program code configured to extract one or more values for the one or more domain independent facets from a document corpus; and
providing one or more query results derived from the document corpus and arranged according to the one or more domain independent facets.

11. The computer program product according to claim 10, wherein the computer readable program code configured to extract one or more values for the one or more domain independent facets from a document corpus further comprises computer readable program code configured to map each document to the one or more values.

12. The computer program product according to claim 10, further comprising computer readable program code configured to rank the one or more query results.

13. The computer program product according to claim 12, wherein the computer readable program code configured to rank is further configured to rank according to semantic features of one or more documents included in the document corpus.

14. The computer program product according to claim 13, wherein the computer readable program code configured to rank is further configured to rank according to syntactic features of one or more documents included in the document corpus.

15. The computer program product according to claim 10, further comprising computer readable program code configured to dynamically provide one or more other query results responsive to a navigation action applying one of the one or more domain independent facets.

16. The computer program product according to claim 10, wherein the query input includes one or more key words.

17. The computer program product according to claim 10, wherein the document corpus comprises web documents.

18. The computer program product according to claim 10, wherein the document corpus comprises enterprise documents.

19. A system comprising:
one or more processors; and
a memory operatively connected to the one or more processors;
wherein, responsive to execution of computer readable program code accessible to the one or more processors, the one or more processors are configured to:
provide a navigation interface having one or more domain independent facets;
receive a query input to the navigation interface;
extract one or more values for the one or more domain independent facets from a document corpus; and
provide one or more query results derived from the document corpus and arranged according to the one or more domain independent facets.

20. The system according to claim 20, wherein to extract one or more values for the one or more domain independent facets from a document corpus further comprises mapping each document to the one or more values.
